(19) United States
(12) Patent Application Publication
(10) Pub. No.: US 2021/0239609 A1
(43) Pub. Date: Aug. 5, 2021

(54) WATER CONTENT SENSOR

(71) Applicant: HEWLETT-PACKARD DEVELOPMENT COMPANY, L.P., Spring, TX (US)

(72) Inventors: Sachiyo YAMADA, Yokohama (JP); Yuichiro TOMISHIMA, Yokohama (JP); Hirokazu YUKAWA, Yokohama (JP)

(73) Assignee: HEWLETT-PACKARD DEVELOPMENT COMPANY, L.P., Spring, TX (US)

(21) Appl. No.: 17/051,748

(22) PCT Filed: Jul. 26, 2019
(86) PCT No.: PCT/US2019/043607

§ 371 Date: Oct. 29, 2020

(30) Foreign Application Priority Data
Aug. 13, 2018 (JP) 2018-152189

(51) Int. Cl. G01N 21/3559; G02B 5/26; G02B 5/20; G02B 26/08; G02B 27/10; G03G 15/00

(52) U.S. Cl. CPC G01N 21/3559; G02B 5/26; G02B 5/208; G03G 2215/00776; G02B 27/106; G03G 15/5029; G03G 2215/0062; G02B 26/0833

(57) ABSTRACT

A water content sensor for a recording medium includes a single light emitting part, a wavelength separation device and a detector device. The single light emitting part emits infrared light in a wavelength range including an absorption wavelength of water along one incident light path toward the recording medium. The wavelength separation device separates infrared light, either reflected from or transmitted through the recording medium, into a first light in a first wavelength range including the absorption wavelength of water and a second light in a second wavelength range excluding the first wavelength range. The detector device receives the first light in the first wavelength range and the second light in the second wavelength range, and generates a first output corresponding to an intensity of the first light received and a second output corresponding to an intensity of the second light received, respectively.

### CROSS REFERENCE TO RELATED APPLICATIONS

This application is a U.S. National Stage Application which claims the benefit under 35 U.S.C. § 371 of International Patent Application No. PCT/US2019/043607 filed on Jul. 26, 2019, which claims priority from Japanese Application No. 2018-152189 filed on Aug. 13, 2018, the contents of each of which are incorporated herein by reference.

### BACKGROUND

In image forming apparatuses using electrophotography such as copiers, printers and facsimile machines, a toner image formed on a photosensitive drum by an image forming process may be transferred on a recording medium (such as paper) by a transfer device, and the toner image may be fixed on the recording medium by a fixing device. In these image forming apparatuses, water content in a recording medium may affect the quality of an image obtained, and the recording medium may be deformed depending on the water content which may cause a jam in the image forming apparatus.

### BRIEF DESCRIPTION OF DRAWINGS

FIGS. 1(a) and 1(b) are schematic diagrams of an example optical configuration of an example water content sensor adjacent a recording medium, the water content sensor including a light emitting part, in which (a) shows the recording medium in an example state, and (b) shows the recording medium in another example state.

FIG. 2 is a graph showing: an example (curve a) for an emission spectrum when the light emitting part shown in FIG. 1(a) is an LED; and an example (thick solid line b) for a wavelength separation characteristic of a dichroic mirror shown in FIG. 1(a).

FIG. 3 is a schematic diagram of an example optical configuration of an example water content sensor including a light emitting part and optical filters.

FIG. 4 is a graph showing: an example (curve a) for an emission spectrum when the light emitting part shown in FIG. 3 is an LED; and an example (thick solid line b and dotted line c) for two wavelength transmission characteristics of the respective optical filters shown in FIG. 3.

FIG. 5 (a) is a schematic diagram of an example optical configuration of an example water content sensor including a light emitting part and a filter switching means; and FIG. 5(b) is a top plan view of the filter switching means shown in FIG. 5(a).

FIG. 6 is a graph showing: an example (curve a) for an emission spectrum when the light emitting part shown in FIG. 5(a) is an LED; and an example (thick solid line b) for a wavelength transmission characteristic of the filter switching means shown in FIG. 5(a).

FIG. 7 is a schematic diagram of an example optical configuration of an example water content sensor including a light emitting part and a MEMS mirror.

FIG. 8 is a graph showing: an example (curve a) for an emission spectrum when the light emitting part shown in FIG. 7 is an LED; and an example (thick solid line b) for a wavelength separation characteristic of a dichroic mirror mounted on the MEMS mirror shown in FIG. 7.

FIG. 9 is a schematic diagram of an example optical configuration of an example water content sensor.

FIG. 10 is a schematic diagram of an example configuration of an example water content sensor, where two light paths of light from respective single light emitting parts are merged into one light path by a light path merging member and where the merged light is emitted to a recording medium.

FIG. 11 is a schematic diagram of an example image forming apparatus having an example water content sensor.

### DETAILED DESCRIPTION

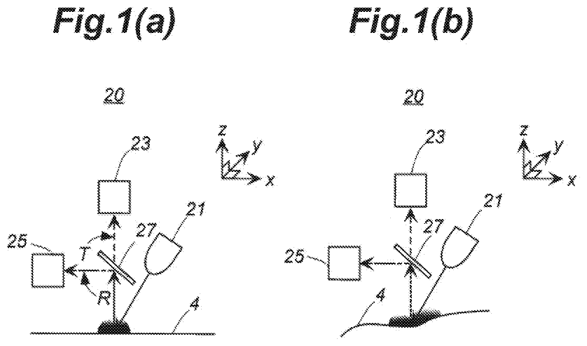

In the following description, with reference to the drawings, the same reference numbers are assigned to the same components or to similar components having the same function, and overlapping description is omitted. With reference to FIG. 1 (a), an optical configuration 20 of an example water content sensor includes a single light emitting part 21 (or light emitter), a wavelength separation means 27 (e.g. a wavelength separation device or a wavelength separator), a first photodetector 23 and a second photodetector 25. A recording medium 4 is disposed on an x-y plane, wherein when viewing FIG. 1(a), a y-axis extends depth-wise and an x-axis extends horizontally, perpendicularly relative to the y-axis. A solid light source element such as an LED (light-emitting diode) or a laser diode may be used as the light emitting part 21. As an example, an LED is used as the light emitting part 21. A photoelectric conversion element such as a photodiode or a phototransistor may be used as the first and second photodetectors 23 and 25 (the above explanation is also applicable to a light emitting part and a photodetector of other examples described below). A dichroic mirror may be used as the wavelength separation means (or wavelength separation device) 27, which may be configured to separate received infrared light into light in a first wavelength range including an absorption wavelength of water, and light in a second wavelength range excluding (e.g. not including) the first wavelength range.

The LED 21 may be a light source for emitting infrared light in a predetermined wavelength range including an absorption wavelength of water (e.g., 1450 nm) along one incident light path, and may be disposed so that an optical axis thereof has an angle of θ (e.g., 30°) relative to the normal line (z-axis direction) of the x-y plane (e.g. where the surface of the recording medium is flat without inclination). The dichroic mirror 27 is disposed to receive the infrared light from the LED 21, which is reflected from the recording medium 4 along one reflection light path; and allows light in the first wavelength range of the received light to be transmitted in a first direction (e.g. the direction indicated by T in FIG. 1(a)) and reflects the light in the second wavelength range in a second direction (e.g. the direction indicated by R in of FIG. 1(a); and in FIG. 1(a), the directions T and R are perpendicular to each other). The first and second photodetectors 23 and 25 are each configured to receive incident light and generate outputs (e.g., current output) corresponding to the intensity of the received light. The first photodetector 23 is disposed to receive light in the first wavelength range, which has been transmitted through the dichroic mirror 27; and the second photodetector 25 is disposed to receive light in the second wavelength range, which has been reflected from the dichroic mirror 27.

The light reflected on the surface of the recording medium 4, includes specular reflected light which reflects the surface state of the recording medium 4 and diffused reflected light which reflects the surface state and the interior state of the recording medium 4. As an example, a glossy recording medium to be used in an image forming apparatus such as a copier, printer or the like, may have a larger ratio of specular reflected light in reflected light, and thus, minimizing the influence of specular reflected light as much as possible may increase accuracy in determining a water content of the recording medium. The dichroic mirror 27 and the photodetectors 23 and 25 are disposed to receive, of the reflected light from the recording medium 4, diffused reflected light but not specular reflected light. According to one example arrangement of the dichroic mirror 27, a reflection surface of the dichroic mirror 27 is disposed above an emission region and inclined at 45° relative to the x-y plane, as shown in FIG. 1(a). The expression “specular reflected light” used in some examples of this description means light that is reflected at substantially the same angle as the incident light angle relative to the normal line of a point of contact between the surface of the recording medium and the incident light and that is reflected from the point of contact in a direction opposite to the incident light. When light emitted from a light emitting part such as the LED 21 is parallel, the angle of the specular reflected light may be determined from the angle of the optical axis thereof. However, since light emitted from a light emitting part such as the LED 21 may be diffused light with a certain degree of spread, the specular reflected light may have a diffusion angle depending on a diffusion angle of emitted light. According to some examples disclosed herein, when the intensity of specular reflected light of a peripheral portion having such a diffusion angle, is small enough to be negligible compared to diffused reflected light from the recording medium, then the wavelength separation device or filter switching means or device (e.g. a filter switch, for example, including a filter portion and light transmissive portion), and detection means or detector device(s) (e.g. photodetectors 23, 25 and the like) of the optical configuration may receive such specular reflected light of the peripheral portion. Thus in the present disclosure, the expressions “being disposed not to receive specular reflected light”, “being disposed to receive no specular reflected light”, and/or the like is not limited to a state of being disposed not to receive at all such specular reflected light of the peripheral portion (e.g. for example, these expressions may be intended to include a configuration by which some specular reflected light is received in a negligible amount compared to diffused reflected light).

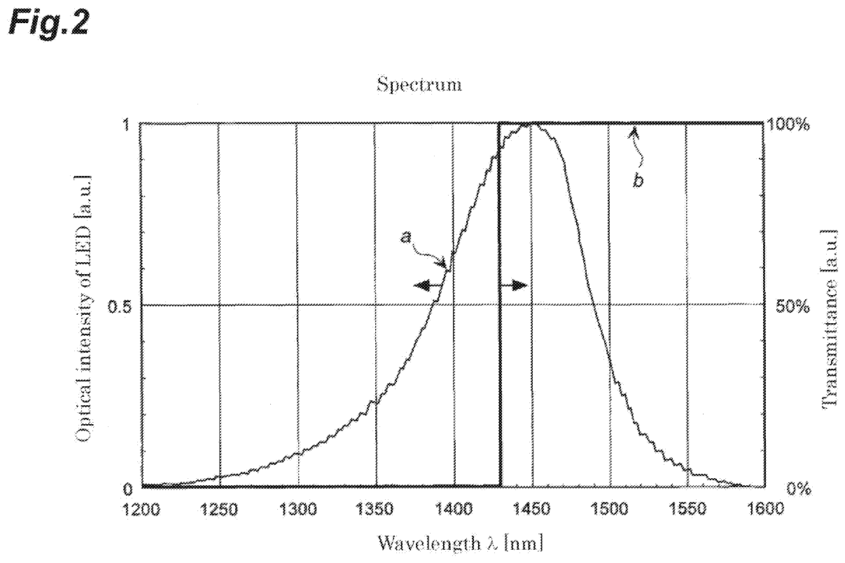

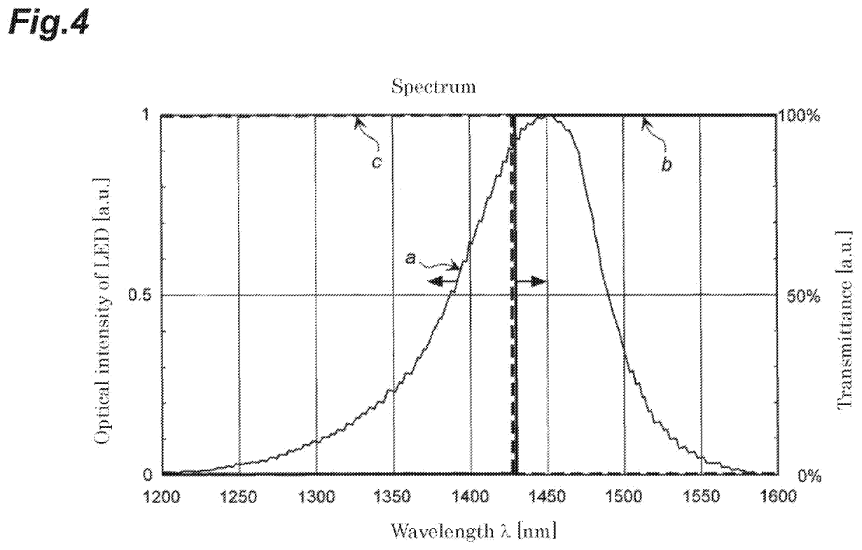

In the graph of FIG. 2, a curve a and a thick solid line b indicate: an emission spectrum of the LED 21 (which is represented as the optical intensity (vertical axis) of the LED 21 relative to the wavelength (horizontal axis) in FIG. 2; and the same may be applicable to FIGS. 4, 6 and 8), and one example of wavelength separation characteristics (which is represented as a transmittance (vertical axis) relative to a wavelength (horizontal axis) in FIG. 2) of the dichroic mirror 27 shown in FIG. 1(a), respectively. As indicated by the curve a in FIG. 2, the emission spectrum of the LED 21 has a peak around 1450 nm, which is an absorption wavelength of water; and has a half-value width (e.g. full width at half maximum) of about 100 nm. As indicated by the thick solid line b, the dichroic mirror 27 allows light in a wavelength range of 1430 nm or more to be transmitted therethrough and reflects light in a wavelength range of less than 1430 nm. In this example, the first wavelength range corresponds to the wavelength range of 1430 nm or more and the second wavelength range corresponds to the wavelength range of less than 1430 nm, respectively.

An operation of the optical configuration 20 shown in FIG. 1(a) will be described. In FIG. 1(a), the recording medium 4 is without any variation in surface level, such as any bend or inclination (or slope). Namely, the surface of the recording medium 4 at least in the emission region is parallel to the x-y plane.

The LED 21 is powered by a light emitting drive circuit (not illustrated), and emits infrared light along one incident light path toward the recording medium 4. The infrared light that is emitted from the LED 21 and reflected from the recording medium 4 along one reflection light path is incident on the dichroic mirror 27 disposed above the recording medium 4. The dichroic mirror 27 allows light in the first wavelength range, of incident light, to be transmitted therethrough toward the first photodetector 23, and reflects light in the second wavelength range, of the incident light, toward the second photodetector 25.

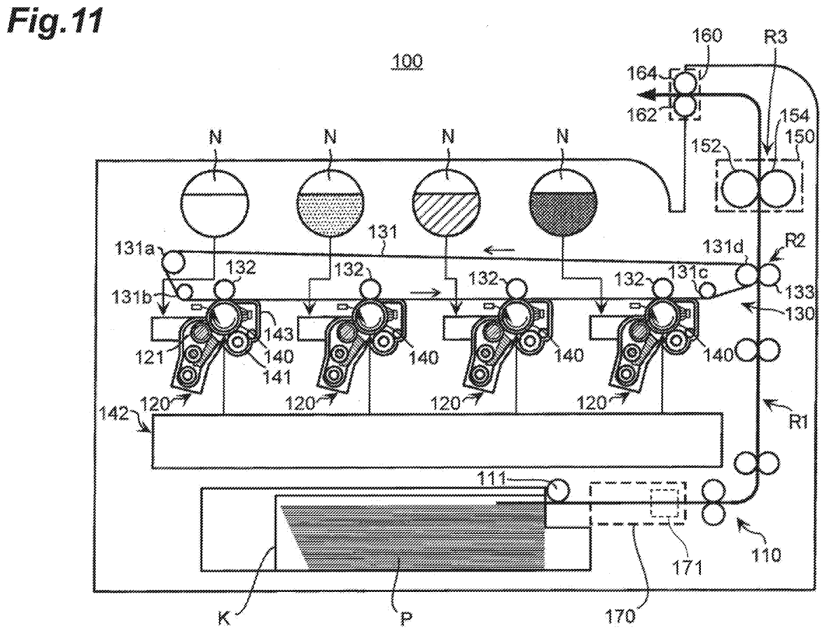

The first photodetector 23 receives the light in the first wavelength range that is transmitted through the dichroic mirror 27 toward the first photodetector 23, and generates an output corresponding to the intensity of the received light. The second photodetector 25 receives the light in the second wavelength range that is reflected from the dichroic mirror 27 towards the second photodetector 25, and generates an output corresponding to the intensity of the received light. In addition, signals corresponding to the received light intensities, which are generated by the first and second photodetectors 23 and 25 in this way, are sent to a computation part (schematically indicated by 171 in the example illustrated in FIG. 11) of the water content sensor (e.g. 170 in FIG. 11), and a water content ratio is calculated at the computation part 171 based on a ratio of these received light intensities.

In FIG. 1(b), the emission region, on the recording medium, of infrared light emitted from the light emitting part is curved, while in FIG. 1(a), the emission region is substantially flat instead of inclined or curved. FIG. 1(b) shows a case in which, when the measurement is made by the optical configuration 20 of FIG. 1(a), the recording medium 4 in the emission region is inclined or curved due to some sort of factor while it should be flat (e.g. along the x-y plane) without inclination or curve. Since the emission region of the recording medium 4 is sloped (inclined) and/or curved, the intensity of light reflected from the emission region or the total sum of the received light intensities detected by the photodetector 23 and 25 is different from the total sum of the received light intensities when the emission region is flat without inclination or curve. However, the optical configuration 20 is configured to separate the same reflected light transmitted along one reflection light path from the same emission region for the light emitted from the LED 21 (or from the single light emitting part) along one incident light path, into light in the first wavelength range and light in the second wavelength range; and to receive them. Thus, the ratio between the intensity of the light in the first wavelength range received by the first photodetector 23 and the intensity of the light in the second wavelength range received by the second photodetector 25 is not changed in comparison to the state where the emission region is in a non-inclined, flat state.

Accordingly, the water content sensor with the optical configuration 20 can provide a ratio of reflection intensity without being affected by such deformation or change even when the recording medium is deformed from an original, non-inclined, flat state and even when the surface level of the recording medium is varied in real-time (during processing) such as during conveyance of the recording medium inside an image forming apparatus; and accordingly, a more accurate water content ratio may be obtained.

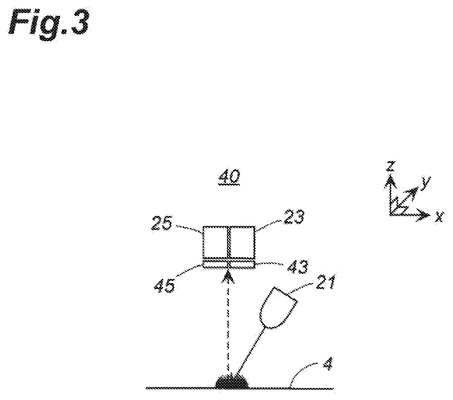

With reference to FIG. 3, an optical configuration 40 of another example water content sensor will be described. The optical configuration 40 shown in FIG. 3 includes two optical filters 43 and 45 which are two bandpass filters; and photodetectors 23 and 25 disposed so as to receive light having passed through the optical filters 43 and 45. The optical filter 43 is a bandpass filter having a passband of a first wavelength range and the optical filter 45 is a bandpass filter having a passband of a second wavelength range. Thus, the light in the first wavelength range of infrared light emitted from the LED 21 along one incident light path and reflected from the recording medium 4 along one reflection light path is transmitted through the optical filter 43 and received by the photodetector 23; while the light in the second wavelength range of infrared light that is reflected from the recording medium 4 along one reflection light path is transmitted through the optical filter 45 and received by the photodetector 25.

The optical filters 43 and 45 and the photodetectors 23 and 25 may be disposed at such positions that they receive, of the light reflected from the recording medium 4, diffused reflected light but not specular reflected light (or to receive substantially no specular reflected light), in order to minimize the effect of the specular reflected light that affects the optical configuration 20 of FIGS. 1(a) and 1(b). FIG. 3 illustrates an example of such an arrangement of the optical filters 43 and 45, wherein the LED 21 has an optical axis angle (which is an angle relative to a z-axis perpendicular to the x-y plane) of 30° while the optical filters 43 and 45 are disposed so that each has a light-receiving surface substantially vertically above an emission region of the LED 21 and facing the x-y plane.

In the graph of FIG. 4, a curve a, a thick solid line b and a dotted line c indicate: an emission spectrum of the example LED 21; and an example for wavelength characteristics of the optical filters 43 and 45 (which are expressed by a transmittance (vertical axis) relative to a wavelength (horizontal axis) in FIG. 4) shown in FIG. 3, respectively. The emission spectrum of the LED 21 may be similar to that of the example illustrated in FIG. 2. The optical filter 43 has a passband in the wavelength range of 1430 nm or more as indicated by the thick solid line b, and the optical filter 45 has a passband in the wavelength range of less than 1430 nm as indicated by the dotted line c. In this example, the first and second wavelength ranges correspond to the wavelength range of 1430 nm or more and the wavelength range of less than 1430 nm, respectively.

An operation of the example optical configuration 40 shown in FIG. 3 will be described. The LED 21 is powered by a light emitting drive circuit (not illustrated), and emits infrared light along one incident light path toward the recording medium 4. The infrared light that is emitted from the LED 21 and reflected from the recording medium 4 along one reflection light path is simultaneously incident on the optical filters 43 and 45 disposed above the recording medium 4. The optical filter 43 allows the light in the first wavelength range of incident light to be transmitted therethrough toward the first photodetector 23, and the optical filter 45 allows the light in the second wavelength range of the incident light to be transmitted therethrough toward the second photodetector 25.

The first photodetector 23 receives the light in the first wavelength range that has been transmitted through the optical filter 43 toward the first photodetector 23, and generates an output corresponding to the intensity of the light received. The second photodetector 25 receives the light in the second wavelength range that has been transmitted through the optical filter 45 toward the second photodetector 25, and generates an output corresponding to the intensity of the light received. Thereafter, signals corresponding to the received light intensities, which are generated by the first and second photodetectors 23 and 25 in a similar manner as in the case of the optical configuration 20, are sent to a computation part (e.g. 171 in FIG. 11) of the water content sensor (e.g. 170 in FIG. 11), and a water content ratio is calculated at the computation part 171 by a method utilizing a ratio of these received light intensities.

Accordingly, the example water content sensor with the optical configuration 40 can produce a more accurate water content ratio, similarly to the optical configuration 20 (FIGS. 1(a) and 1(b)). In some examples, the first photodetector 23 and the second photodetector 25 of the optical configuration 20 illustrated in FIG. 1(a) can be additionally integrated with the optical configuration 40, and disposed at similar relative positions as in the optical configuration 20, in order to make the water content sensor more compact in size compared to the optical configuration 20.

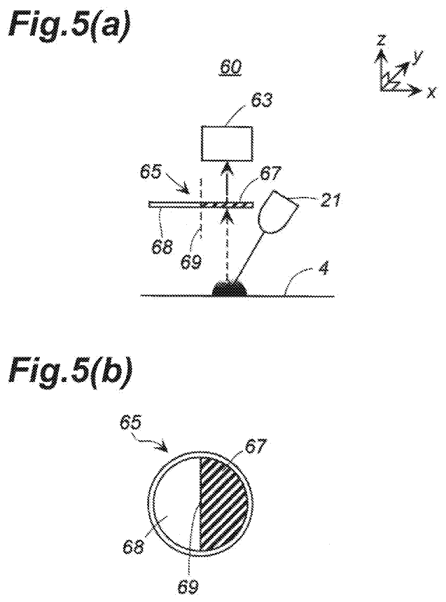

With reference to FIGS. 5(a) and 5(b), an optical configuration 60 of another example water content sensor includes filter switching means (or filter switch or filter switching device) 65 and a photo detector 63 for receiving the light that has been transmitted through the filter switching means 65. The filter switching means 65 has: a filter portion 67 having as a passband a predetermined wavelength range including the first wavelength range (hereinafter, the “predetermined wavelength range” is referred to as “first predetermined wavelength range”) and a light transmissive portion 68 for transmitting, without attenuation, light in the entire wavelength range including the first predetermined wavelength range. In some examples, it is possible to dispose these two portions alternatively in the same position. For example, the two portions may be movable to occupy the same position, at alternating points in time. An example filter switching means 65 as shown in FIG. 5(b), includes a rotating disk having the filter portion 67 attached to a first semicircular portion and the light transmissive portion 68 (e.g., opening) disposed at the other semicircular portion, and the rotating disk is arranged to rotate around a central axis 69, in order to switch between: receiving by the filter portion 67 the light reflected from the recording medium 4 and transmitting the received light to the photodetector 63; and receiving by the light transmissive portion 68 the light and transmitting the received light to the photodetector 63.

In examples where the filter switching means 65 includes such a rotating disk, the filter switching means 65 may be disposed rotatably relative to the photodetector 63, to be positioned in a first rotational position and in a second rotational position. In the first rotational position, the filter switching means 65 exclusively allows light that is transmitted through the filter portion 67, of infrared light from the LED 21 and reflected by the recording medium 4 to be incident on the filter switching means 65, to be sent to the photodetector 63. In the second rotational position (for example, a position rotated by 180° from the first rotational portion), filter switching means 65 exclusively allows light that is transmitted through the light transmissive portion 68, of infrared light from the LED 21 and reflected by the recording medium 4 to be incident on the filter switching means 65, to be sent to the photodetector 63. The filter switching means 65 may be configured to include two members having the same wavelength transmittance properties as the filter portion 67 and the light transmissive portion 68, respectively, alternatively disposed in the same position without being limited to such a rotating disk.

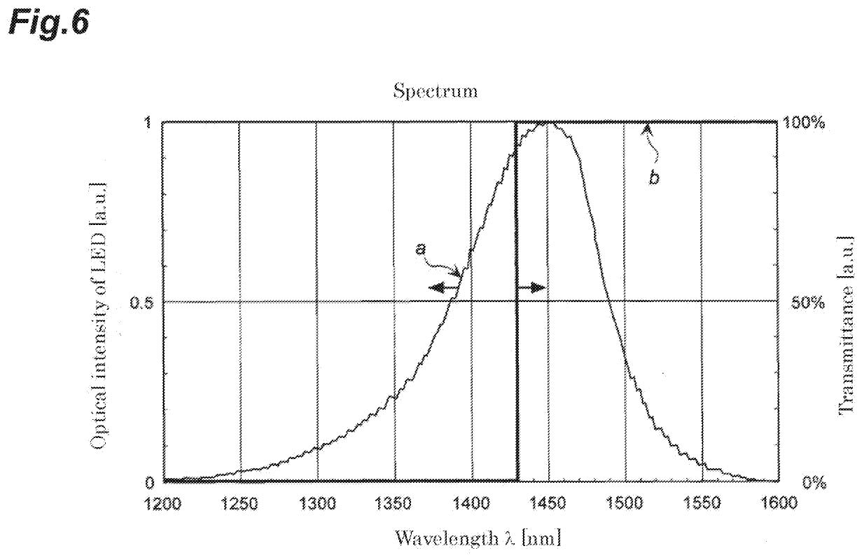

In the graph of FIG. 6, a curve a and a thick solid line b indicate: an emission spectrum of the LED 21; one example for wavelength transmittance property of the filter portion of the filter switching means 65 (which is expressed as the transmittance (vertical axis) relative to the wavelength (horizontal axis) in FIG. 6) shown in FIG. 5(a), respectively. In this example, the emission spectrum of the LED 21 is the same as that in FIG. 2. When the filter switching means 65 is located in the first rotational position, the filter switching means 65: allows light in a wavelength range of 1430 nm or more to be transmitted therethrough; but prevents light in a wavelength range of less than 1430 nm (thick solid line b), of the infrared light that is emitted by the LED 21, reflected from the recording medium 4 and incident on the filter portion 67. When the filter switching means 65 is located in the second rotational position, the filter switching means 65 allows light in the entire wavelength range including infrared light from the LED 21 that is reflected from the recording medium 4 and is incident on the filter portion 68 to be transmitted therethrough as-is without attenuation. In this example, the first predetermined wavelength range and the second wavelength range correspond to a wavelength range of 1430 nm or more and the entire wavelength range (including the wavelength range of 1430 nm or more), respectively. Since the second wavelength range includes the first predetermined wavelength range, the computation part (e.g. 171 in FIG. 11) of the water content sensor (e.g. 170 in FIG. 11) subtracts the magnitude of the output corresponding to the light intensity of the first predetermined wavelength range generated by the photodetector 63 from the magnitude of the output corresponding to the light intensity of all wavelength ranges generated by the photodetector 63, thereby providing a light intensity of wavelength range excluding (e.g. not including) the first predetermined wavelength range.

In order not to minimize the effect of specular reflected light in the example optical configuration 60 illustrated in FIG. 5(a), the filter switching means 65 and the photodetector 63 may be disposed in a similar manner as in the optical configuration 20 so that: the filter portion 67 and the photodetector 63 when the filter switching means 65 is in the first rotational position, or the light transmissive portion 68 and the photodetector 63 when the filter switching means 65 is in the second rotational position, receive diffused reflected light but receive substantially no specular reflected light, of the light reflected from the recording medium 4. An example arrangement of filter switching means 65 is shown in FIGS. 5(a) and 5(b), wherein the LED 21 has an optical axis angle of, for example, 30° while the filter portion 67 and the light transmissive portion 68 when the filter switching means 65 is in the first and second rotational positions, respectively, are disposed such that they are located substantially vertically above an emission region of the LED 21 and light-receiving surfaces thereof face the x-y plane.

An operation of the optical configuration 60 shown in FIGS. 5(a) and 5(b) will be described with regard to the case where the filter switching means 65 includes the above rotating disk. The filter switching means 65 is rotated to the first rotational position by rotation drive means (not illustrated). The LED 21 is powered by a light emitting drive circuit (not illustrated) and emits infrared light along one incident light path toward the recording medium 4. The infrared light that is emitted from the LED 21 and reflected from the recording medium 4 along one reflection light path is incident on the filter switching means 65 disposed above the recording medium 4. Of the incident infrared light, light in the first predetermined wavelength range (which is a wavelength range of 1430 nm or more in the example of FIG. 6) exclusively, is transmitted through the filter portion 67 and sent to the photodetector 63. The photodetector 63 receives the light sent from the filter portion 67 and generates an output (which is referred to as “first rotational position output”) corresponding to the intensity of the received light. The filter switching means 65 is rotated by 180° to the second rotational position by the rotation drive means. The LED 21 is powered by the light emitting drive circuit (not illustrated) and emits infrared light along one incident light path toward the recording medium 4. The infrared light that is emitted from the LED 21 and reflected from the recording medium 4 along one reflection light path, is incident on the light transmissive portion 68, which is located at the same position as that of the filter portion 67 when in the first rotational position. The infrared light that is incident on the light transmissive portion 68 in the entire wavelength range is transmitted through the light transmissive portion 68 and sent to the photodetector 63. The photodetector 63 receives the light sent from the light transmissive portion 68 and generates an output (which is referred to as “second rotational position output”) corresponding to the intensity of the received light.

The output generated by the photodetector 63 is sent to the computation part (e.g. 171 in FIG. 11) and a water content ratio of the recording medium 4 is determined. It should be noted that the example optical configuration 60 illustrated in FIG. 5(a) may not directly measure the received light intensity of light exclusively in a wavelength range excluding the first predetermined wavelength range. For example, when the size of the first rotational position output is represented as A and the size of the second rotational position output is represented as B, the computation part (e.g. 171 in FIG. 11) may calculate the intensity of the light in the wavelength range excluding the first predetermined wavelength range as a value corresponding to the value determined by subtracting A from B. The computation part 171 may calculate a water content ratio by a method utilizing a ratio of the light intensity corresponding to A and the light intensity determined as the value corresponding to the value determined by subtracting A from B. The example water content sensor having the optical configuration 60 includes means for identifying whether an output generated by one photodetector 63 is the first rotational position output or the second rotational position output from rotational position information of the filter switching means 65.

Accordingly, even when the recording medium is deformed from an original, flat state (e.g. where the recording medium is not inclined, sloped, or curved), the water content sensor with the optical configuration 60 can provide a ratio of reflection intensity while minimizing the effects of such deformation; and provide a more accurate water content ratio. In addition, since this configuration may be achieved with one photodetector, the water content sensor may be produced in a more inexpensive and compact manner.

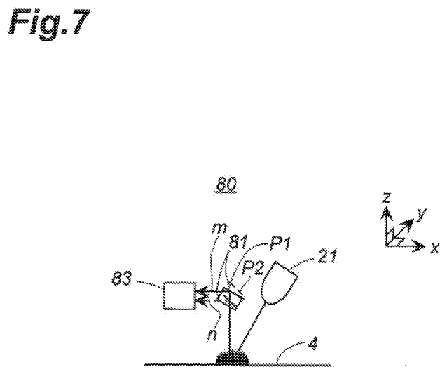

With reference to FIG. 7, an optical configuration 80 of an example water content sensor includes a MEMS (Micro Electro Mechanical System) mirror 81 and a photodetector 83 for receiving light emitted from the MEMS mirror 81. The MEMS mirror 81 has a mirror surface mounted with an optical member in which wavelength separation means such as a dichroic mirror and a light path-changing member such as a prism are combined.

Hereafter, a case where the dichroic mirror 27 of FIG. 1(a) is adopted as the wavelength separation means (or wavelength separation device) of the optical member will be described. In a similar manner as in the explanation for FIGS. 1(a) and 1(b), infrared light is emitted by the LED 21 along one incident light path toward the recording medium 4 and reflected from the recording medium 4 along one reflection light path. The dichroic mirror receives the reflected infrared light; and transmits the light in the first wavelength range toward a first direction (this transmitted light is referred to as transmitted light T) and reflects the light in the second wavelength range toward a second direction (this reflected light is referred to reflected light R). The light path-changing member is combined with the dichroic mirror 27 so as to change one light path or both light paths of the transmitted light T and the reflected light R from the dichroic mirror 27 and to emit the transmitted light T and the reflected light R in substantially the same direction. The photodetector 83 is disposed to receive the transmitted light T and the reflected light R emitted from the MEMS mirror 81.

The MEMS mirror 81 includes a driving member capable of changing a mirror angle and is arranged to take positions P1 and P2 as illustrated in FIG. 7, by electrical operation. The first position P1 is a position for: receiving infrared light that is reflected from the emission region of the LED 21 and emitting the transmitted light T in a direction incident on the photodetector 83 (the direction indicated by character m in FIG. 7); and for emitting the reflected light R in a direction not incident on the photodetector 83 (not illustrated). The second position P2 is a position for: emitting the reflected light R in a direction incident on the photodetector 83 (the direction indicated by character n in FIG. 7), and emitting the transmitted light T in a direction not incident on the photodetector 83 (not illustrated).

Thus, in the first position P1, the transmitted light T from the dichroic mirror is incident on the photodetector 83 while the reflected light R from the dichroic mirror is not incident on the photodetector 83; and thus, the photodetector 83 detects the intensity of the light in the first wavelength range. In the second position P2, the reflected light R from the dichroic mirror is incident on the photodetector 83 while the transmitted light T from the dichroic mirror is not incident on the photodetector 83; and thus, the photodetector 83 detects the intensity of the light in the second wavelength range. It should be noted that a specific position is dependent on a structure of the wavelength separation means mounted on the MEMS mirror 81; and a similar function may be implemented by employing, as the wavelength separation means, a diffraction grating or an interference filter instead of a dichroic mirror. The light path-changing member is not limited to a prism, and may include an optical member configured to work in a similar manner as described above on a light path of either one of two wavelength ranges separated by the wavelength separation means, or light paths of both.

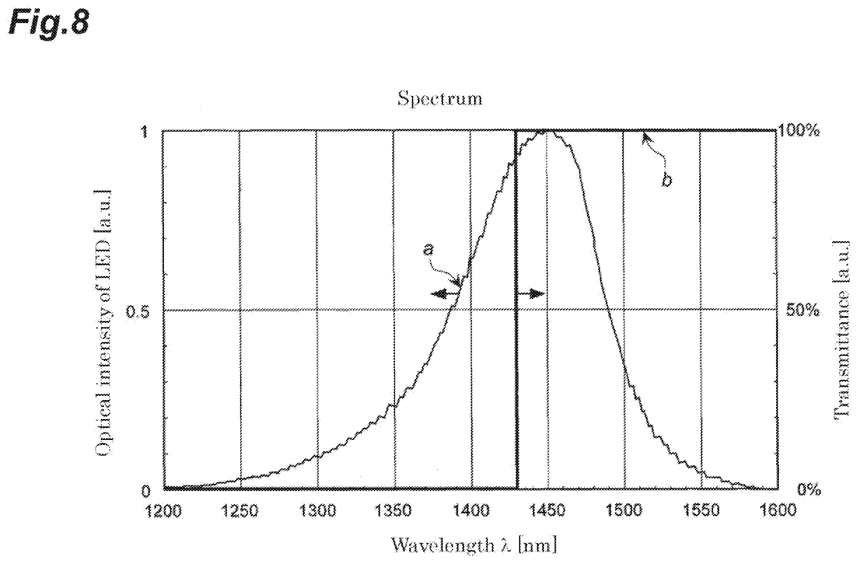

In the graph of FIG. 8, a curve a and a thick solid line b respectively indicate: an emission spectrum of the LED 21; and one example for wavelength separation characteristics of the dichroic mirror mounted on the MEMS mirror 81 (which is expressed by a transmittance (vertical axis) relative to a wavelength (horizontal axis) in FIG. 8) shown in FIG. 7. In this example, the emission spectrum of the LED 21 and the wavelength separation characteristics of the dichroic mirror are similar to those of FIG. 2. That is, the dichroic mirror transmits light in the wavelength range of 1430 nm or more as indicated in the thick solid line b; and reflects light in the wave length range of less than 1430 nm. Thus, the first wavelength range (wavelength range of transmitted light T) and the second wavelength range (wavelength range of reflected light R) correspond to the wavelength range of 1430 nm or more and the wavelength range of less than 1430 nm, respectively.

An operation of the optical configuration 80 shown in FIG. 7 will be described. The MEMS mirror 81 is operated to position the MEMS mirror 81 at the first position P1. The LED 21 is powered by a light emitting drive circuit (not illustrated) to emit infrared light along one incident light path toward the recording medium 4. The infrared light that is emitted from the LED 21 and reflected from the recording medium along one reflection light path is incident on the MEMS mirror disposed above the recording medium 4. Of the infrared light having been incident on the MEMS mirror 81, light in the first wavelength range is emitted to the photodetector 83 by the optical member mounted on the MEMS mirror 81. The photodetector 83 receives the light emitted from the MEMS mirror 81 and generates an output corresponding to the intensity of the received light (first output). The MEMS mirror 81 is operated to position the MEMS mirror 81 at the second position P2. The LED 21 is powered by the light emitting drive circuit, and the infrared light emitted from the LED 21 and reflected from the recording medium 4 is incident on the MEMS mirror 81. Of the infrared light having been incident on the MEMS mirror 81, light in the second wavelength range is emitted to the photodetector 83 by the optical member mounted on the MEMS mirror 81. The photodetector 83 receives the light emitted from the MEMS mirror 81 and generates an output corresponding to the intensity of the received light (second output).

The example optical configuration 80 includes no more than one photodetector, and the first output and the second output are differentiated for determining a water content ratio. The water content sensor identifies whether the output generated by photodetector 83 is:

an output (first output) generated when the photodetector 83 receives the light emitted by the MEMS mirror 81 in response to reception of infrared light emitted from the LED 21 at the time when the MEMS mirror 81 is in the first position P1; or

an output (second output) generated when the photodetector 83 receives the light emitted by the MEMS mirror 81 in response to reception of infrared light emitted from the LED 21 at the time when the MEMS mirror 81 is in the second position P2. The example water content sensor includes output identification means for making such identification by use of, for example, drive timing information indicating each timing for driving the MEMS mirror 81 to take position P1 or P2 and drive timing information indicating a timing for driving the LED 21. The timing relationship between the drive timing of each of the above timing of the MEMS mirror 81 and the drive timing of the LED 21 may be determined in advance, in order to allow the output identification means to make the above identification using the drive timing information of the MEMS mirror 81. Accordingly, the first and second outputs generated by the photodetector 83 may be sent to the computation part (e.g. 171 in FIG. 11) of the water content sensor (e.g. 170 in FIG. 11), and the computation part 171 may determine a water content ratio by a method utilizing a ratio of these outputs (that is, intensity of received light).

In order to minimize effects of specular reflected light in the example optical configuration 80 illustrated in FIG. 7, the MEMS mirror 81 and the photodetector 83 are disposed in a similar manner as in the optical configuration 20. Accordingly, of reflected light from the recording medium 4, the MEMS mirror 81 and the photodetector 83 receive diffused reflected light but receive substantially no specular reflected light. An example of such an arrangement of the MEMS mirror 81 is shown in FIG. 7, wherein the LED 21 has an optical axis angle of 30° while the MEMS mirror 81 is disposed above an emission region.

Even when the recording medium is deformed from an original, flat state (e.g. where the recording medium is not inclined, sloped or curved), the water content sensor with the optical configuration 60 can provide a ratio of reflection intensity while minimizing the effects of such deformation, in order to provide a more accurate water content ratio. In addition, since this configuration may be achieved with one photodetector at such a position that it can receive light emitted from the MEMS mirror 81, the water content sensor may be achieved more easily and inexpensively.

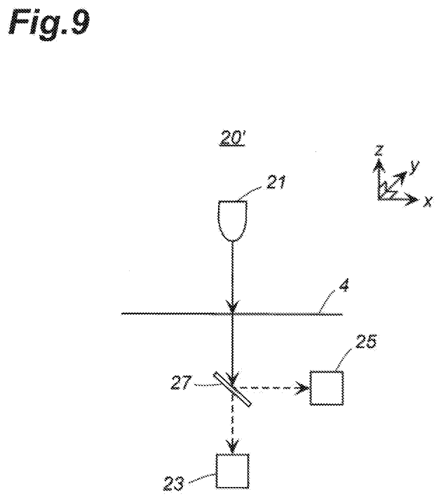

The above example optical configurations 20, 40, 60 and 80 may detect the intensity of light reflected from a recording medium, and they may be configured to detect the intensity of transmitted light of the recording medium. For example, the wavelength separation means (or wavelength separation device) or filter switching means (or filter switching device) of the optical configurations 20, 40, 60 and 80, may be modified so as to receive transmitted light from the recording medium 4. An example optical configuration 20′ illustrated in FIG. 9 has a single light emitting part (LED 21) for emitting infrared light along one incident light path to the recording medium 4, wavelength separation means (dichroic mirror 27), and two detection means (e.g. photodetectors 23 and 25) in a similar manner as the optical configuration 20 illustrated in FIGS. 1(a) and 1(b). The LED 21 is disposed to have an optical axis parallel to the z-axis, and the recording medium 4 is disposed between the LED 21, and the dichroic mirror 27 and two photodetectors 23, 25. Accordingly, the dichroic mirror 27 receives infrared light from the LED 21 that is transmitted through the recording medium 4 along one transmission light path, and light in the first wavelength range transmitted through the dichroic mirror 27 and light in the second wavelength range reflected by the dichroic mirror 27 are received by the first and second photodetectors 23 and 25, respectively. The dichroic mirror 27 receives infrared light that is emitted from the LED 21 and transmitted through the recording medium.

It is to be understood that not all aspects, advantages and features described herein may necessarily be achieved by, or included in, any one particular example. Indeed, having described and illustrated various examples herein, it should be apparent that other examples may be modified in arrangement and detail is omitted. For example, modified configurations referred to as optical configurations I, II and III (not illustrated in the drawings), include a modification to detect the intensity of transmitted light transmitted through the recording medium 4 along one transmission light path, similarly to the optical configuration 20′.

The example optical configuration I of an example water content sensor includes a single light emitting part (LED 21) for emitting infrared light along one incident light path to the recording medium 4, wavelength separation means (optical filters 43 and 45), and two detection means (e.g. photodetectors 23 and 25) similarly to the example optical configuration 40 illustrated in FIG. 3. In the optical configuration I, the LED 21 is disposed to have an optical axis parallel to the z-axis (see FIG. 9), and the recording medium 4 is disposed between the LED 21, and the optical filters 43 and 45 and the two photodetectors 23 and 25 so that the optical filters 43 and 45 receive infrared light that is emitted from the LED 21 and transmitted through the recording medium 4, and light transmitted through each of these filters is received by each of the first and second photodetectors 23 and 25.

The example optical configuration II of an example water content sensor has a single light emitting section (LED 21) for emitting infrared light along one incident light path to the recording medium 4, filter switching means 65, and one detection means or single detector (e.g. photodetector 63) similarly to the example optical configuration 60 illustrated in FIG. 5(a). In the optical configuration II, the LED 21 is disposed to have an optical axis parallel to the z-axis (see FIG. 9), and the recording medium 4 is disposed between the LED 21; and the filter switching means 65 and the photodetector 63 so that infrared light that is emitted from the LED 21 and transmitted through the recording medium 4 along one transmission light path is received sequentially by a filter portion 67 and a light transmissive portion 68 of the filter switching means 65; and light transmitted through each of the filter portion 67 and the light transmissive portion 68 is received by the photodetector 63.

The example optical configuration III of an example water content sensor includes a single light emitting part (LED 21) for emitting infrared light along one incident light path to the recording medium 4, a MEMS mirror 81 and one detection means or single detector (e.g. photodetector 83) in similarly to the optical configuration 80 illustrated in FIG. 7. In the optical configuration Ill, the LED 21 is disposed to have an optical axis parallel to z-axis (see FIG. 9), and the recording medium 4 is disposed between the LED 21, and the MEMS mirror 81 and the photodetector 83 so that when the MEMS mirror 81 is in a position corresponding to each of the first and second positions, the photodetector 83 receives infrared light which is from the LED 21 and transmitted through the recording medium along one transmission light path, and is incident on the MEMS mirror 81 and emitted from the MEMS mirror 81.

The optical configurations I, II and II operate similarly to the optical configurations 40, 60 and 80, with some differences. For example, infrared light that is emitted from the LED 21 and transmitted through the recording medium 4 is received by wavelength separation means (optical filters 43 and 45 in the optical configuration I), filter switching means (filter switching means 65 in the optical configuration II), or the MEMS mirror (MEMS mirror 81 in the optical configuration III). In the example optical configurations 20′, I, II and III, the optical axis of the LED 21 as a light emitting part, is not limited to an optical axis in a direction parallel to the z-axis as indicated in FIG. 9, but it may be an optical axis in a direction at a certain angle (for example, 60°) relative to the z-axis. The example optical configuration may be modified to receive light that is emitted from the LED 21 and passed through the recording medium 4.

Examples Using a Light Path-Merging Member

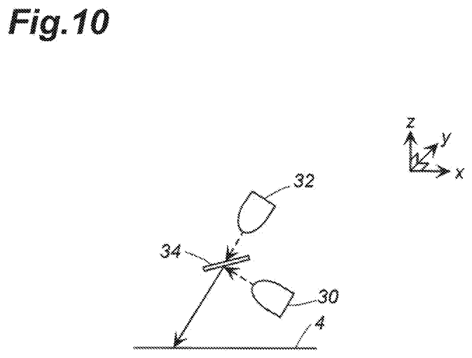

The example optical configurations 20, 40, 60, 80, 20′, I, II and III may be modified to include a plurality of light emitting parts and a light path-merging member. Light is merged from the plurality of light emitting parts to one light path by the light path-merging member, to be directed (or emitted) to a recording medium. After the merged light is incident on the recording medium along the one light path, subsequent operations to detect an intensity of light reflected from or transmitted through the recording medium by a photodetector may be similar to those of the optical configurations 20, 40, 60, 80, 20′, I, II and III. At least one of the plurality of light emitting parts may include an absorption wavelength of water so that the merged light has a wavelength range including the absorption wavelength of water and wavelengths other than the above as indicated, for example, as the curve a in FIG. 2. FIG. 10 illustrates an example where such a plurality of light emitting parts and a light path-merging member are formed by two LEDs 30 and 32 and a dichroic mirror 34, respectively. The dichroic mirror 34 is configured: to reflect light from the LED 30 as a single light emitting part and transmit light from the LED 32 as the other single light emitting part, and to merge reflected light and transmitted light into one light path. The dichroic mirror 34 is disposed to direct (or emit) the merged light to the recording medium 4 along the one light path.

For example, in a modified arrangement, the LED 21 of the optical configuration 20 illustrated in FIG. 1(a) is replaced with two LEDs 30 and 32, and the dichroic mirror 34 of FIG. 10. In this modified arrangement, light emitted from the LED 30 to the dichroic mirror 34 is reflected by the dichroic mirror 34 while light emitted from the LED 32 to the dichroic mirror 34 is transmitted through the dichroic mirror 34. The reflected light and transmitted light are merged into one light path and directed (or emitted) to the recording medium 4. At least one of the LEDs 30 and 32 emits infrared light including an absorption wavelength of water (for example, the LED 30 may be an LED for emitting infrared light in a wavelength range including an absorption wavelength of water while the LED 32 may be an LED for emitting infrared light in a wavelength range excluding the wavelength of water). The merged light that is incident on the recording medium 4 and reflected from the recording medium 4 along one reflection light path is separated by the dichroic mirror 27 (similarly to the configuration in FIG. 1(a)), and an intensity of each separated light is detected by each of the photodetectors 23 and 25 (with reference to FIG. 1(a)). It should be noted that the plurality of light emitting parts are not limited to two light emitting parts as shown in FIG. 10, but three or more light emitting parts (for example, three or more LEDs) may be employed, with a light path-merging member such as a light-merging prism for merging light from three or more light emitting parts into one light path.

Example Imaging Apparatus Including an Example Water Content Sensor

With reference to FIG. 11, an image forming apparatus 100 includes a water content sensor 170. The image forming apparatus 100 may be a printer for printing an image on a recording medium by electrophotography. The image forming apparatus 100 may form a color image using each color of magenta, yellow, cyan and black. The example image forming apparatus 100 has a feeding device 110 (conveyance mechanism) for conveying paper P, a developing device 120 for developing an electrostatic latent image, a transfer device 130 for secondary transfer of a toner image on the paper P, a photosensitive drum 140 as an electrostatic latent image carrier having an outer circumferential surface, on which the image is formed, a fixing device 150 for fixing the toner image on the paper P, a discharge device 160 for discharging the paper P, and a water content sensor 170. The developing device 120, the transfer device 130, the photosensitive drum 140, the fixing device 150, and others form an image forming processing part, which carries out image forming processing on the paper P fed out by the paper feeding roller 111.

The example feeding device 110 may convey the paper P as a recording medium, on which an image is formed, along a feeding path R1. The paper P is stacked and accommodated in a cassette K, and picked up and fed by a paper feeding roller 111. The feeding device 110 allows the paper P to arrive at a secondary transfer range R2 through the feeding path R1 at the timing when a toner image to be transferred to the paper P arrives at the secondary transfer range R2. The example water content sensor 170 is disposed between the paper feeding roller 111 and the feeding device 110 downstream of the paper feeding roller 111. The water content sensor 170 may be disposed at any other suitable location along the feeding path of the paper P, in other examples.

A developing device 120 is provided for each of the four colors. Each developing device 120 has a developing roller 121 for toner to be carried on a photosensitive drum 140. The developing device 120 adjusts a mixing ratio of toner and carrier to a desired ratio, and further, mixes and stirs them to prepare a developer having toner uniformly dispersed and an optimal charge amount imparted thereto. This developer is carried on the developing roller 121. When the rotation of the developing roller 121 conveys the developer to a range facing the photosensitive drum 140, the toner of the developer carried on the developing roller 121 is moved onto the electrostatic latent image formed on the outer circumferential surface of the photosensitive drum 140, and the electrostatic latent image is developed.

The transfer device 130 conveys a toner image formed by the developing device 120 to the secondary transfer range R2 where the toner image is to be secondarily transferred to the paper P. The transfer device 130 has a transfer belt 131, suspending rollers 131a, 131b, 131c and 131d suspending the transfer belt 131, a primary transfer roller 132 holding the transfer belt 131 together with the photosensitive drum 140, and a secondary transfer roller 133 holding the transfer belt 131 with the suspending roller 131d.

The transfer belt 131 is an endless belt, which is circularly driven by suspending rollers 131a, 131b, 131c and 131d. The primary transfer roller 132 is provided so as to press the photosensitive drum 140 from an inner circumference of the transfer belt 131. The secondary transfer roller 133 is provided so as to press the suspending roller 131d from an outer circumference of the transfer belt 131.

A photosensitive drum 140 is provided for each of the four colors. Each photosensitive drum 140 is provided along a moving direction of the transfer belt 131. On the periphery of the photosensitive drum 140, there are provided the developing device 120, a charging roller 141, an exposure unit 142, and a cleaning unit 143.

The charging roller 141 provides charging means that uniformly charge the surface of the photosensitive drum 140 at a predetermined electric potential. The charging roller 141 is driven while following the rotation of the photosensitive drum 140. The exposure unit 142 exposes, to the light, the surface of the photosensitive 140, which is charged by the charging roller 141, in accordance with the image to be formed on the paper P. This changes the electric potential of a portion, which has been exposed by the exposure unit 142, of the surface of the photosensitive drum 140, thereby forming an electrostatic latent image. Each of the four developing devices 120 develops an electrostatic latent image formed on the associated photosensitive drum 140 by toner supplied from the corresponding toner tank N that faces the developing device 120, so that a toner image is generated. The toner tanks N are each filled with one of magenta, yellow, cyan and black toners. The cleaning unit 143 collects toner remaining on the photosensitive drum 140 after the toner image formed on the photosensitive drum 140 is primarily transferred to the transfer belt 131.

The fixing device 150 adheres and fixes the toner image, which is secondarily transferred from the transfer belt 131 to the paper P, by passing the paper through a nip portion R3 for heating and pressing. The fixing device 150 has a heating roller 152 (heating rotation body) for heating the paper P and a pressing roller 154 (pressing rotation body) for rotating and driving the heating roller 152 by pressing it. The heating roller 152 and the pressing roller 154 are formed in a cylindrical shape, and the heating roller 152 includes a heat source such as a halogen lamp located in the heating roller 152. The nip portion R3 as a contact range is provided between the heating roller 152 and the pressing roller 154, to fuse and fix the toner image on the paper P by passing the paper P through the nip portion R3.

The discharge device 160 includes discharge rollers 162 and 164. The discharge rollers 162 and 164 discharge the paper P having the toner image fixed thereon by the fixing device 150 to an outside of the apparatus.

In the example image forming apparatus 100, the water content sensor 170 may have an optical configuration according to the optical configuration 20 (FIG. 1(a)), 40 (FIG. 3), 60 (FIG. 5(a)) or 80 (FIG. 7), to detect the intensity of reflected light from the recording medium. While the paper P is being conveyed within the image forming apparatus 100, a water content ratio of the paper P, for example, during conveyance of the paper P from the cassette K to the image forming processing part may be determined as follows. At a predetermined timing after the paper P is fed by the paper feeding roller 11 and enters a measurement range of the water content sensor 170, the LED 21 emits infrared light to the paper P. Outputs corresponding to reflected light intensities of the first and second wavelength ranges from the paper P may be generated, as previously described in regards to the example optical configurations 20, 40, 60 and 80. The outputs corresponding to respective reflected light intensities are sent to the computation part 171 of the water content sensor 170, and a water content ratio of the paper P is determined based on these outputs at the computation part 171. The computing part 171 may include a processor to execute processor-readable instructions, and/or a memory to store data and instructions for the processor.

In some examples, the water content sensor 170 may have an optical configuration according to the optical configuration 20′, I, II or III configured to detect the intensity of transmitted light from the recording medium. For example, with the example optical configuration 20′ illustrated in FIG. 9, while the paper P is being conveyed within the image forming apparatus 100, a water content ratio of the paper P, for example, during conveyance of the paper P from the cassette K to the image forming processing part may be determined as follows. At a predetermined timing after the paper P is fed by the paper feeding roller 11 and enters a measurement range of the water content sensor 170, the LED 21 emits infrared light to the paper P. The infrared light transmitted through the paper P is separated by the dichroic mirror 27. The first and second photodetectors 23 and 25 generate outputs corresponding to transmitted light intensities of the first and second wavelength ranges, respectively, as previously described with regard to the optical configuration 20. The outputs corresponding to respective transmitted light intensities are sent to the computation part 171 of the water content sensor 170 and a water content ratio of the paper P is determined based on a ratio of the transmitted light intensities. The optical configuration 60 or the optical configuration II determine received light intensities of light in the wavelength range excluding reflected light/transmitted light in the first predetermined wavelength range, in order to determine the water content ratio.

The water content ratio of the paper P determined by the water content sensor 170 may be used as information for controlling the developing device 120, the transfer device 130, the photosensitive 140 and the fixing device 150.

According to some examples, in an image forming apparatus, a water content sensor may be arranged with an optical configuration to determine a more accurate water content ratio of the recording medium, even when the surface level of the recording medium is varied, while minimizing effects by such variation, in order to control the image forming process and medium conveyance more suitably, based on the more accurate water content ratio. For example, a water content sensor may be provided with the optical configurations 20, 40, 20′ to obtain a more accurate water content ratio even in a situation where the surface level of the recording medium is varied real-time. Accordingly, a more accurate water content ratio may be determined even during conveyance of the recording medium within the example image forming apparatus without stopping the conveyance of the recording medium, to avoid slowing down the processing speed of the image forming apparatus. According to some examples, an image formation process or conveyance of a recording medium can be controlled depending on the water content, in order to improve image quality and/or prevent or minimize the occurrences of paper jams in an image forming apparatus.

1. A water content sensor to determine a water content ratio of a recording medium, comprising:
a single light emitting part to emit infrared light in a wavelength range including an absorption wavelength of water along one incident light path toward the recording medium;
a wavelength separation device to separate one of infrared light reflected from the recording medium along a reflection light path and infrared light transmitted through the recording medium along a transmission light path, into a first light in a first wavelength range including the absorption wavelength of water and a second light in a second wavelength range excluding the first wavelength range; and
a detector device to receive the first light in the first wavelength range and the second light in the second wavelength range, and to generate a first output corresponding to an intensity of the first light received and a second output corresponding to an intensity of the second light received, respectively.

2. The water content sensor according to claim 1, wherein the detector device comprises:
a first detector to receive the first light in the first wavelength range and to generate the first output corresponding to the intensity of the first light received; and
a second detector to receive the second light in the second wavelength range and to generate the second output corresponding to the intensity of the second light received.

3. The water content sensor according to claim 1, wherein the wavelength separation device includes a dichroic mirror.

4. The water content sensor according to claim 1, wherein the wavelength separation device comprises a first optical filter having a passband corresponding to the first wavelength range to generate the first light, and a second optical filter having a passband corresponding to the second wavelength range to generate the second light.

5. The water content sensor according to claim 1, wherein, when the wavelength separation device is disposed to receive the infrared light reflected from the recoding medium along the one reflection light path, the wavelength separation device is disposed in a position to receive substantially no specular reflected light of the infrared light reflected from the recording medium.

6. The water content sensor according to claim 1, comprising a light path-merging member and a plurality of light emitting parts including the single light emitting part, at least one of the plurality of light emitting parts to emit infrared light in a wavelength range including the absorption wavelength of water, and the light path-merging member to merge light from the plurality of light emitting parts into one light path and to emit light merged into the one light path to the recording medium.

7. The water content sensor according to claim 1, comprising a computing part to determine a water content ratio of the recording medium based, at least in part, on the first output and the second output.

8. The water content sensor according to claim 1, wherein the wherein the single light emitting part comprises an LED.

9. The water content sensor according to claim 1, wherein the wavelength separation device comprises:
a MEMS mirror to receive either one of the infrared light reflected from the recording medium along the reflection light path and the infrared light transmitted through the recording medium along the transmission light path, wherein the MEMS mirror is operable in a first position and in a second position; and
an optical member mounted to the MEMS mirror to emit the first light in the first wavelength range of the infrared light received by the MEMS mirror, along a direction incident on the detector device and to emit the second light in the second wavelength range of the infrared light received by the MEMS mirror, along a direction not incident on the detector device, when the MEMS mirror is in the first position; and to emit the second light in the second wavelength range of the infrared light received by the MEMS mirror toward the detector device and to emit the first light in the first wavelength range of the infrared light received by the MEMS mirror along a direction not incident on the detector device, when the MEMS mirror is in the second position.

10. A water content sensor to determine a water content ratio of a recording medium, comprising:
a single light emitting part to emit infrared light in a wavelength range including an absorption wavelength of water along one incident light path to the recording medium;
a filter switching device comprising: a filter portion having, as a passband, a predetermined wavelength range including the absorption wavelength of water in received infrared light corresponding to one of infrared light reflected from the recording medium along one reflection light path and infrared light transmitted through the recording medium along one transmission light path; and a light transmissive portion to transmit light in an entire wavelength range, including the predetermined wavelength range, of the received infrared light; and
a detector to receive light transmitted through the filter portion and the light transmissive portion of the filter switching device to generate an output corresponding to an intensity of the received light,
the filter switching device to alternately position the filter portion and the light transmissive portion at a predetermined position to receive the received infrared light, and
the filter switching device being disposed relative to the detector so that: when the filter portion is disposed in the predetermined position, light transmitted through the filter portion, of the received infrared light received by the filter portion, is sent to the detector; and when the light transmissive portion is disposed in the predetermined position, light transmitted through the light transmissive portion, of the received infrared light received by the light transmissive portion, is sent to the detector.

11. The water content sensor according to claim 10, wherein, when the filter portion and the light transmissive portion are each disposed in the predetermined position to receive the infrared light reflected from the recording medium along the one reflection light path, the predetermined position is in a position to receive substantially no specular reflected light of the infrared light reflected from the recording medium.

12. An image forming device having a sensor to determine a water content ratio of a recording medium, comprising:
a single light emitting part to emit infrared light in a wavelength range including an absorption wavelength of water along one incident light path toward the recording medium;
a wavelength separation device to separate one of infrared light reflected from the recording medium along one reflection light path and infrared light transmitted through the recording medium along one transmission light path, into a first light in a first wavelength range including the absorption wavelength of water and a second light in a second wavelength range excluding the first wavelength range; and
a detector device to receive the first light in the first wavelength range and the second light in the second wavelength range, and to generate a first output corresponding to an intensity of the first light received and a second output corresponding to an intensity of the second light received, respectively.

13. The image forming device according to claim 12, wherein the detector device comprises:
a first detector to receive the first light in the first wavelength range and to generate the first output corresponding to the intensity of the first light received; and
a second detector to receive the second light in the second wavelength range and to generate the second output corresponding to the intensity of the second light received.

14. The image forming device according to claim 12, comprising a light path-merging member and a plurality of light emitting parts including the single light emitting part, at least one of the plurality of light emitting parts to emit infrared light in a wavelength range including the absorption wavelength of water, and the light path-merging member to merge light from the plurality of light emitting parts into one light path and to emit light merged into the one light path to the recording medium.

15. The image forming device according to claim 12, wherein the wavelength separation device comprises:
a MEMS mirror to receive either one of the infrared light reflected from the recording medium along one reflection light path and the infrared light transmitted through the recording medium along one transmission light path, wherein the MEMS mirror is operable in a first position and in a second position; and
an optical member mounted to the MEMS mirror to emit the first light in the first wavelength range, of the infrared light received by the MEMS mirror, along a direction incident on the detector device and to emit the second light in the second wavelength range excluding the light in the first wavelength range, of the infrared light received by the MEMS mirror, along a direction not incident on the detector device when the MEMS mirror is in the first position; and to emit the second light in the second wavelength range of the infrared light received by the MEMS mirror toward the detector device and to emit the first light in the first wavelength range of the infrared light received by the MEMS mirror along a direction not incident on the detector device when the MEMS mirror is in the second position.
